(19) United States
(12) Patent Application Publication
(10) Pub. No.: US 2013/0081503 A1
(43) Pub. Date: Apr. 4, 2013

(54) ROBOT ARM ASSEMBLY

(71) Applicant: BO LONG, Shenzhen City (CN)

(72) Inventor: BO LONG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/400,815

(22) Filed: Feb. 21, 2012

(30) Foreign Application Priority Data
Sep. 30, 2011 (CN) 201110297220.1

(51) Int. Cl. B25J 17/00

(52) U.S. Cl. 74/490.05; 901/26; 901/28

(57) ABSTRACT

A robot arm assembly includes a first arm, a second arm and a third arm. The first arm includes a main body, a pivotal portion perpendicularly connected to the main body, a first transmission mechanism and a first reducer. The second arm includes a fixing portion, a second transmission mechanism, a first connecting portion and a second connecting portion extending from opposite ends of the fixing portion. The first connecting portion and the second connecting portion are connected to opposite ends of the pivotal portion, the second transmission mechanism is connected to the first transmission mechanism. The third arm includes an output flange, a second reducer connected to the output flange and a transmission bevel gear. The transmission bevel gear is fixed to the input end and engages with the second transmission mechanism.

### BACKGROUND

1. Technical Field

The present disclosure relates to industrial robots, and more particularly, to a robot arm assembly of an industrial robot.

2. Description of Related Art

A robot arm assembly may include a base and a plurality of arms connected with each other in turn, such as a fourth arm, a fifth arm and a sixth arm. For instance, two sides of an end of the fourth arm may be connected to a bevel gear and a reducer respectively. The fifth arm includes a fixing portion, a first connecting portion and a second connecting portion extending perpendicularly from opposite ends of the fixing portion in a same direction. The first connecting portion is connected to the bevel gear; the second connecting portion is fixedly sleeved on the reducer. The sixth arm includes a transmission bevel gear. The fixing portion is sleeved on the transmission bevel gear to connect the fifth arm with the sixth arm. However, an engaging clearance defined between the transmission bevel gear and the fifth arm increases due to an abrasion of the transmission bevel gear, thus the sixth arm has a low transmission accuracy, and a low repeatability or positioning accuracy.

Therefore, there is room for improvement in the art.

### BRIEF DESCRIPTION OF THE DRAWINGS

The components in the drawings are not necessarily drawn to scale, the emphasis instead placed upon clearly illustrating the principles of the present disclosure. Moreover, in the drawings, like reference numerals designate corresponding parts throughout the several views.

FIG. 1 is an assembled, isometric view of an embodiment of a robot arm assembly.

FIG. 2 is a cross-section of the robot arm assembly of FIG. 1 taken along line II-II.

FIG. 3 is an isometric view of a cover of the robot arm assembly of FIG. 1.

FIG. 4 is an isometric view of a fixing portion, a first connecting portion and a second connecting portion of the robot arm assembly of FIG. 1.

### DETAILED DESCRIPTION

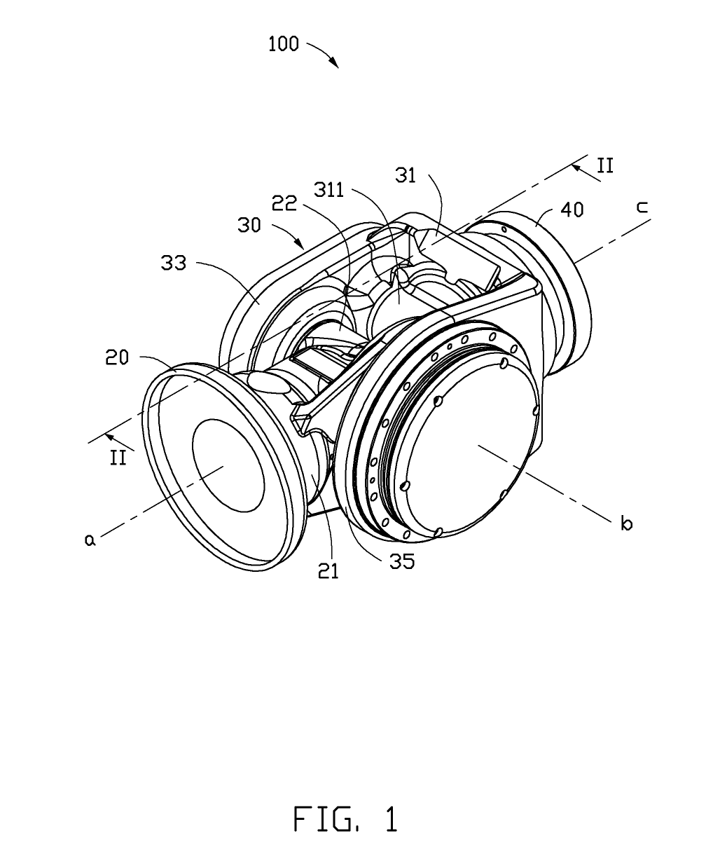

Referring to FIG. 1, an embodiment of a robot arm assembly 100 includes a first arm 20, a second arm 30 and a third arm 40. The first arm 20 and the third arm 40 are rotatably connected to opposite ends of the second arm 30. In the embodiment, the robot arm assembly 100 is employed in a six-axis industrial robot. The first arm 20, the second arm 30 and the third arm 40 are capable of rotating along a first axis a, a second axis b and a third axis c, respectively. The first axis a is coaxial with the second axis b, and perpendicular to the third axis c. The third arm 40 is positioned at an output end of the robot arm assembly 100, an execution mechanism may be fixed to the third arm 40, such as a clamping member or a cutter.

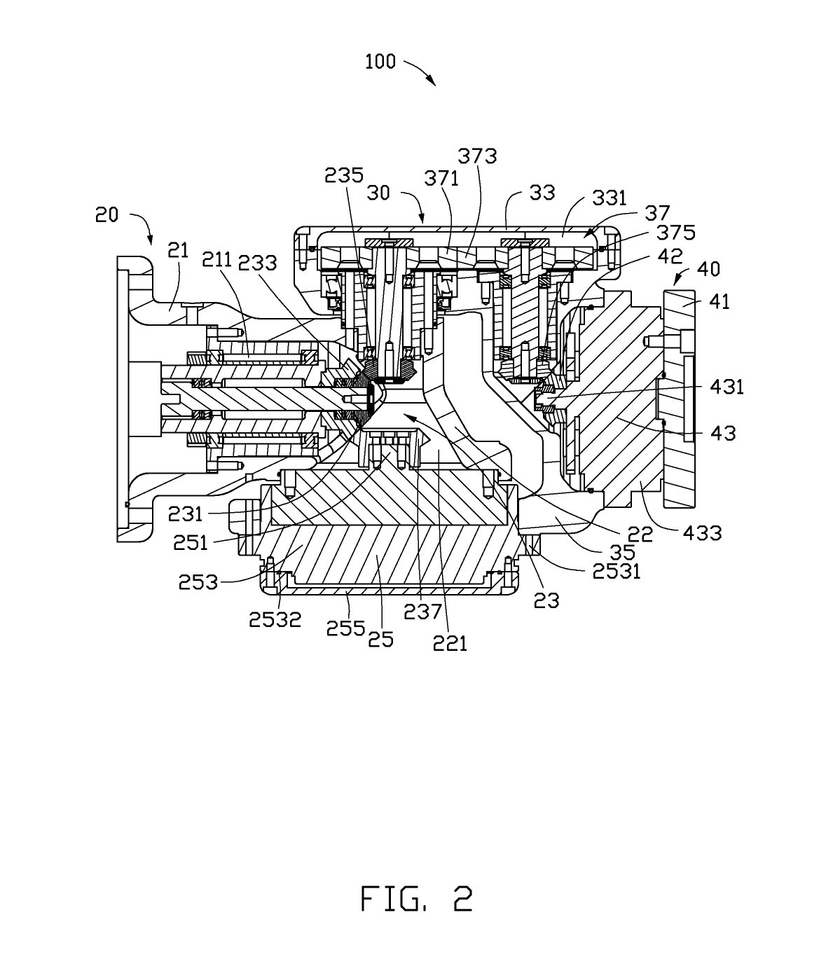

Also referring to FIG. 2, the first arm 20 is substantially in the shape of a “T”, and includes a main body 21, a pivotal portion 22 perpendicularly connected to an end of the main body 21, a first transmission mechanism 23 and a first reducer 25.

The main body 21 is arranged along the first axis a, the pivotal portion 22 is arranged along the second axis b. The main body 21 defines a first receiving chamber 211 along the axis a, and the pivotal portion 22 defines a second receiving chamber 221 along the second axis b. The first receiving chamber 211 communicates with the second receiving chamber 221. The first transmission mechanism 23 is received in the first receiving chamber 211 and the second receiving chamber 221, and includes a first bevel gear 231, a second bevel gear 233, a third bevel gear 235 and a fourth bevel gear 237. The first bevel gear 231 and the second bevel gear 233 are received in the first receiving chamber 211, and arranged along the first axis a. The first bevel gear 231 and the second bevel gear 233 are located adjacent to the pivotal portion 22, the second bevel gear 233 is rotatably sleeved on the first bevel gear 231. The third bevel gear 235 and the fourth bevel gear 237 are received in the second receiving chamber 221, and arranged along the second axis b. The third bevel gear 235 and the fourth bevel gear 237 are opposite to each other, and located adjacent to the main body 21. The third bevel gear 235 engages with the first bevel gear 231, and the fourth bevel gear 237 engages with the second bevel gear 233. The first reducer 25 is mounted at an end of the pivotal portion 22 opposite to the third bevel gear 235, and connected to the fourth bevel gear 237.

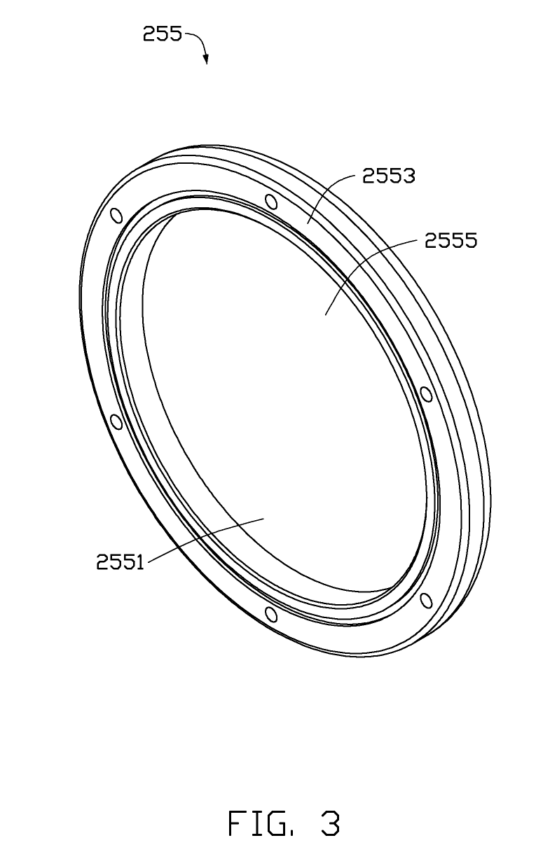

The first reducer 25 includes an input shaft 251, an output shaft 253 opposite to the input shaft 251, and a cover 255 mounted on the output shaft 253. The input shaft 251 is fixedly inserted in the fourth bevel gear 237. The output shaft 253 includes an annular output portion 2531 and an annular stepped portion 2532. The output portion 2531 is a rib formed around the periphery of the middle of the output shaft 253. The stepped portion 2532 is located at an end of the first reducer 25 away from the fourth bevel gear 237. Also referring to FIG. 3, the cover 255 has a bowl shape and is located at an end of the output shaft 253 away from the input shaft 251 to shield a portion of the output shaft 253. The cover 255 includes a circular bottom plate 2551 and an annular sidewall 2553 substantially perpendicularly extending from edges of the bottom plate 2551. The sidewall 2553 connects with the bottom plate 2551 smoothly and defines a receiving space 2555 together with the bottom plate 2551. The first reducer 25 is partially received in the receiving space 2555.

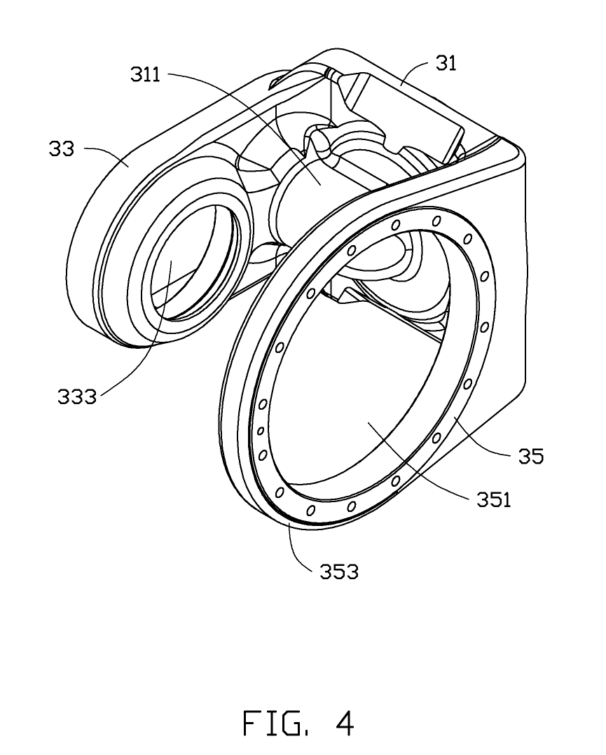

Also referring to FIG. 4, the second arm 30 is substantially in the shape of an “n”, an outside of the top of the “n” connects with the third arm 40. The second arm 30 includes a fixing portion 31, a first connecting portion 33, a second connecting portion 35 and a second transmission mechanism 37. The first connecting portion 33 and the second connecting portion 35 perpendicularly extend from opposite ends of the fixing portion 31. The first connecting portion 33 and the second connecting portion 35 are rotatably connected to opposite ends of the pivotal portion 22 of the first arm 20. The first connecting portion 33 is hollow, and the second transmission mechanism 37 is received in the first connecting portion 33.

The fixing portion 31 includes a protrusion 311 adjacent to the first connecting portion 33. The protrusion 311 and the first connecting portion 33 cooperatively define a third receiving chamber 331. The first connecting portion 33 defines a circular hole 333 at an end away from the fixing portion 31. The circular hole 333 communicates with the third receiving chamber 331, and faces the second connecting portion 35. The second connecting portion 35 defines a sleeving hole 351. The second connecting portion 35 includes an annular portion 353 configured around the sleeving hole 351. The annular portion 353 is sleeved on the output portion 2531 of the first reducer 25. In the embodiment, the second connecting portion 35 is substantially annular. The second transmission mechanism 37 includes a fifth bevel gear 371, a sixth bevel gear 373 and a seventh bevel gear 375. The third bevel gear 235 includes a shaft portion (not labeled) extending through the circular hole 333 of the first connecting portion 33 and partially received in the third receiving chamber 331. The fifth bevel gear 371 is sleeved on the shaft portion of the third bevel gear 235 and received in the third receiving chamber 331. The sixth bevel gear 373 is received in the third receiving chamber 331 and engages with the fifth bevel gear 371. The sixth bevel gear 373 is located adjacent to the fixing portion 31, and the seventh bevel gear 375 is rotatably received in the third receiving chamber 331 and adjacent to the third arm 40. The seventh bevel gear 375 has a shaft portion (not labeled) extending into the sixth bevel gear 373 to enable the seventh bevel gear 375 to be fixed to the sixth bevel gear 373.

Referring to FIG. 2, the third arm 40 is rotatably connected to the fixing portion 31. The third arm 40 includes an output flange 41, a transmission bevel gear 42 and a second reducer 43. The second reducer 43 includes an input shaft 431 and an output shaft 433 opposite to the input shaft 431. The transmission bevel gear 42 is sleeved on the input shaft 431 of the second reducer 43, and engages with the seventh bevel gear 375. The output flange 41 is fixed to the output shaft 433, and capable of rotating relative to the fixing potion 31.

Referring to FIGS. 1 through 4, in assembly, the second bevel gear 233 is rotatably sleeved on the first bevel gear 231. The first bevel gear 231 and the second bevel gear 233 are rotatably received in the first receiving chamber 211 of the main body 21. The pivotal portion 22 is perpendicularly mounted on the main body 21. The third bevel gear 235 is rotatably mounted on an end of the pivotal portion 22 to engage with the first bevel gear 231. The fifth bevel gear 371 is fixedly sleeved on the shaft portion of the third bevel gear 235. An end of the pivoting portion 22 extends into the circular hole 333 of the first connecting portion 33 and is received in the third receiving chamber 331, with the fixing portion 31 of the second arm 30 located away from the pivotal portion 22. The cover 255 is fixed to the first reducer 25 with the sidewall 2553 abutting against and fixed to the stepped portion 2532. The second connecting portion 35 is sleeved on the middle of the first reducer 25 via the sleeving hole 351, and the annular portion 353 of the second connecting portion 35 resists the output portion 2531. The fourth bevel gear 237 is fixedly sleeved on the input shaft 251 of the first reducer 25. The fourth bevel gear 237 and the first reducer 25 are mounted on an end of the pivotal portion 22 away from the third bevel gear 235. The fourth bevel gear 237 engages with the second bevel gear 233. The sixth bevel gear 373 and the seventh bevel gear 375 are rotatably received in the third receiving chamber 331. The sixth bevel gear 373 is fixedly sleeved on the shaft portion of the seventh bevel gear 375, and engages with the fifth bevel gear 371. The transmission bevel gear 42 is sleeved on the input shaft 431 of the second reducer 43, and engages with the seventh bevel gear 375. The output flange 41 is fixed to the output shaft 433 of the second reducer 43.

The transmission process of the robot arm assembly 100 is as follows: when the first arm 20 rotates, the main body 21 of the first arm 20 drives the second arm 30 and the third arm 40 to rotate along the first axis a. When the second bevel gear 233 drives the fourth bevel gear 237 to rotate, the fourth bevel gear 237 drives the second arm 30 and the third arm 40 to rotate along the second axis b via the first reducer 25. When the first bevel gear 231 drives the third bevel gear 235 to rotate, the third bevel gear 235 drives the transmission bevel gear 42 to rotate via the fifth bevel gear 371, the sixth bevel gear 373 and the seventh bevel gear 375, and then the transmission bevel gear 42 drives the third arm 40 to rotate along the third axis c via the second reducer 43.

In the robot arm assembly 100, the input shaft 431 of the second reducer 43 is fixed to the transmission bevel gear 42, and the second reducer 43 is located at the output end of the transmission process. Thus any transmission errors of the bevel gears of the robot arm assembly 100 are decreased, and the robot arm assembly 100 is capable of operating with a higher accuracy. Furthermore, the cover 255 and the second connecting portion 35 are distanced from each other, and when the second connecting portion 35 whips or is deformed or ruptured, the cover 255 is capable of avoiding from experiencing the negative effect from the second connecting portion 35 that is damaged or defective, and thus the cover 255 is capable of sealing the first reducer 25 hermetically to prevent oil leakage. As the second connecting portion 35 is sleeved on the middle of the first reducer 25, and when the second connecting portion 35 is subjected to an undue amount of torque, the first reducer 25 can prevent the rupture of the second connecting portion 35, unlike a conventional second connecting portion wherein the conventional second connecting portion is connected to an end portion of the first reducer 25.

The robot arm assembly 100 can functions beyond the requirements of a six axis robot. The robot arm assembly 100 of the present disclosure can also be employed in three, four, or five axis robots. Different stages of the transmission process of the robot arm assembly 100, according to needs or requirements, may be utilized.

While various embodiments have been described and illustrated, the disclosure is not to be construed as being restricted thereto. Various modifications can be made to the embodiments by those skilled in the art without departing from the true spirit and scope of the disclosure as defined by the appended claims.

What is claimed is:

1. A robot arm assembly, comprising:
a first arm comprising a main body, a pivotal portion perpendicularly connected to an end of the main body, a first transmission mechanism and a first reducer, the main body defining a first receiving chamber, the pivotal portion defining a second receiving chamber communicating with the first receiving chamber, the first transmission mechanism being received in the first receiving chamber and the second receiving chamber;
a second arm comprising a fixing portion, a second transmission mechanism, a first connecting portion and a second connecting portion extending from opposite ends of the fixing portion, the first connecting portion being rotatably connected to a first end of the pivotal portion; the second connecting portion being rotatably connected to a second end of the pivotal portion opposite to the first end of the pivotal portion via the first reducer, the second transmission mechanism being received in the fixing portion and the first connecting portion, and the second transmission mechanism being connected to the first transmission mechanism; and
a third arm comprising:
an output flange;
a second reducer connected to the output flange; and
a transmission bevel gear, the output flange being fixed to an output end of the second reducer, the transmission bevel gear being fixed to an input end of the second reducer and engaging with the second transmission mechanism.

2. The robot arm assembly of claim 1, wherein the second reducer comprises an input shaft and an output shaft opposite to the input shaft, the transmission bevel gear is fixedly sleeved on the input shaft, and the output flange is fixed to the output shaft.

3. The robot arm assembly of claim 1, wherein the first transmission mechanism comprises a first bevel gear, a second bevel gear, a third bevel gear and a fourth bevel gear, the first bevel gear and the second bevel gear are received in the first receiving chamber, and the second bevel gear is rotatably sleeved on the first bevel gear, the third bevel gear and the fourth bevel gear are received in the second receiving chamber and arranged opposite to each other, the third bevel gear engages with the first bevel gear, and the fourth bevel gear engages with the second bevel gear.

4. The robot arm assembly of claim 3, wherein the first connecting portion and the second connecting portion are parallel to each other and substantially perpendicular to the fixing portion, the fixing portion and the first connecting portion cooperatively define a third receiving chamber, the second transmission mechanism is received in the third receiving chamber, and comprises a fifth bevel gear and a sixth bevel gear, the fifth bevel gear is fixed to the third bevel gear, the sixth bevel gear engages with the fifth bevel gear and is capable of driving the transmission bevel gear to rotate.

5. The robot arm assembly of claim 4, wherein the fixing portion comprises a protrusion adjacent to the first connecting portion, the third receiving chamber is defined in the protrusion and the first connecting portion, the sixth bevel gear is located adjacent to the fixing portion, the second transmission mechanism further comprises a seventh bevel gear, the seventh bevel gear is rotatably received in the third receiving chamber and has a shaft portion extending into the sixth bevel gear to enable the seventh bevel gear to be fixed to the sixth bevel gear, and the seventh bevel gear engages with the transmission bevel gear.

6. The robot arm assembly of claim 4, wherein the first connecting portion further defines a circular hole at an end away form the fixing portion, the circular hole communicates with the third receiving chamber and faces the second connecting portion, the third bevel gear comprises a shaft portion extending through the circular hole and partially received in the third receiving chamber, and the fifth bevel gear is sleeved on the shaft portion of the third bevel gear.

7. The robot arm assembly of claim 4, wherein the second connecting portion defines a sleeving hole at the end away from the fixing portion, the second connecting portion comprises an annular portion configured around the sleeving hole, the second connecting portion is sleeved on the first reducer via the sleeving hole.

8. The robot arm assembly of claim 7, wherein the first reducer comprises an input shaft, an output shaft opposite to the input shaft and a cover mounted on the output shaft, the input shaft is fixedly inserted in the fourth bevel gear, the output shaft comprises an annular output portion around the periphery of the output shaft, the annular portion of the second connecting portion is fixed to the output portion of the first reducer.

9. The robot arm assembly of claim 8, wherein the output shaft further comprises a stepped portion located at an end of the first reducer away from the fourth bevel gear, the cover comprises a bottom plate and an annular sidewall substantially perpendicularly extending from edges of the bottom plate, the sidewall is fixed to the stepped portion to connect the cover with the first reducer.

10. The robot arm assembly of claim 9, wherein the sidewall connects with the bottom plate smoothly and defines a receiving space together with the bottom plate, the first reducer is partially received in the receiving space.

11. A robot arm assembly, comprising:
a first arm comprising a main body, a pivotal portion perpendicularly connected to an end of the main body and a first transmission mechanism, the first transmission mechanism being received in the main body and the pivotal portion, and the first transmission mechanism comprising a first bevel gear, a second bevel gear, a third bevel gear and a fourth bevel gear, the second bevel gear being rotatably sleeved on the first bevel gear, the third bevel gear engaging with the first bevel gear, and the fourth bevel gear engaging with the second bevel gear,
a second arm comprising a fixing portion, a second transmission mechanism, a first connecting portion and a second connecting portion, the first connecting portion and the second connecting portion extending from opposite ends of the fixing portion, the first connecting portion being rotatably connected to a first end of the pivotal portion, the second connecting portion being rotatably connected to a second end of the pivotal portion opposite to the first end via the fourth bevel gear; the second transmission mechanism being partially received in the first connecting portion, and comprising a fifth bevel gear and a sixth bevel gear, the fifth bevel gear being fixed to the third bevel gear, the sixth bevel gear engaging with the fifth bevel gear; and
a third arm comprising:
a reducer; and
a transmission bevel gear fixed to the input end of the reducer and driven by the sixth bevel gear.

12. The robot arm assembly of claim 11, wherein the reducer comprises an input shaft and an output shaft opposite to the input shaft, the transmission bevel gear is fixedly sleeved on the input shaft, and the third arm further comprises an output flange fixed to the output shaft of the reducer.

13. The robot arm assembly of claim 11, wherein the main body defines a first receiving chamber, the pivotal portion defines a second receiving chamber communicating with the first receiving chamber, the first bevel gear and the second bevel gear are received in the first receiving chamber, the third bevel gear and the fourth bevel gear are received in the second receiving chamber and arranged opposite to each other.

14. The robot arm assembly of claim 13, wherein the first connecting portion and the second connecting portion are parallel to each other and substantially perpendicular to the fixing portion, the first connecting portion and the fixing portion cooperatively define a third receiving chamber, the fifth bevel gear and the sixth bevel gear are received in the third receiving chamber.

15. The robot arm assembly of claim 14, wherein the fixing portion comprises a protrusion adjacent to the first connecting portion, the third receiving chamber is defined in the protrusion and the first connecting portion, the sixth bevel gear is located adjacent to the fixing portion, the second transmission mechanism further comprises a seventh bevel gear rotatably received in the third receiving chamber, the seventh bevel gear has a shaft portion extending into the sixth bevel gear to enable the seventh bevel gear to be fixed to the sixth bevel gear, and the seventh bevel gear engages with the transmission bevel gear.

16. The robot arm assembly of claim 14, wherein the first connecting portion further defines an circular hole at an end away form the fixing portion, the circular hole communicates with the third receiving chamber and faces the second connecting portion, the third bevel gear comprises a shaft portion extending through the circular hole and partially received in the third receiving chamber, the fifth bevel gear is fixedly sleeved on the shaft portion of the third bevel gear.

17. The robot arm assembly of claim 14, wherein the second connecting portion defines a sleeving hole at the end away from the fixing portion, the second connecting portion comprises an annular portion around the sleeving hole, the first arm further comprises a first reducer connected to the fourth bevel gear, the second connecting portion is sleeved on the first reducer via the sleeving hole.

18. The robot arm assembly of claim 17, wherein the first reducer comprises an input shaft, an output shaft opposite to the input shaft and a cover mounted on the output shaft, the input shaft is fixedly inserted in the fourth bevel gear, the output shaft comprises an annular output portion configured around the periphery of the output shaft, the annular portion of the second connecting portion is fixed to the output portion of the first reducer.

19. The robot arm assembly of claim 18, wherein the output shaft further comprises a stepped portion located at an end of the first reducer away from the fourth bevel gear, the cover comprises a bottom plate and an annular sidewall substantially perpendicularly extending from edges of the bottom plate, the sidewall is fixed to the stepped portion to connect the cover with the first reducer.

20. The robot arm assembly of claim 19, wherein the sidewall connects with the bottom plate smoothly and defines a receiving space together with the bottom plate, the first reducer is partially received in the receiving space.
